(19) United States
(12) Patent Application Publication
(10) Pub. No.: US 2007/0122217 A1
(43) Pub. Date: May 31, 2007

(54) IMAGE FORMING APPARATUS & ASSOCIATED METHOD OF APPLYING A LUBRICANT

(76) Inventors: Hiroyuki Nagashima, Yokohama-shi (JP); Hiroshi Hosokawa, Yokohama-shi (JP); Yoshiyuki Kimura, Tokyo (JP); Masanori Kawasumi, Yokohama-shi (JP); Takeshi Uchitani, Kamakura-shi (JP); Atsushi Sampe, Yokohama-shi (JP); Nobuo Kuwabara, Yokohama-shi (JP); Yuji Arai, Kawasaki-shi (JP); Hirotaka Hatta, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/565,404

(22) Filed: Nov. 30, 2006

(30) Foreign Application Priority Data
Nov. 30, 2005 (JP) 2005-345026
Feb. 27, 2006 (JP) 2006-050228

(51) Int. Cl. G03G 21/00

(52) U.S. Cl. 399/346

(57) ABSTRACT

An image forming apparatus includes a main body, and a process cartridge detachably disposed in the main body and an image bearing member. The image bearing member provides an image on a surface thereof and rotate at a predetermined linear velocity. A lubricant applying member contacts the image bearing member and applies a lubricant on the surface of the image bearing member while rotating with the image bearing member. The lubricant applying member includes a brush roller and is controlled to rotate at a linear velocity different from the predetermined linear velocity of the image bearing member at a contact portion with the image bearing member. In this way, the lubricant applying member applies an amount of the lubricant smaller than an amount of lubricant used when the image bearing member and the lubricant applying member rotate at an identical linear velocity.

### BACKGROUND OF THE INVENTION

1. Field of the Invention

The “background” description provided herein is for the purpose of generally presenting the context of the invention. Work of the presently named inventors, to the extent it is described in this background section, as well as aspects of the description which may not otherwise qualify as prior art at the time of filing, are neither expressly or impliedly admitted as prior art against the present invention.

The present invention relates to an image forming method and apparatus for effectively applying lubricant. More particularly, the present invention relates to a process cartridge that can effectively apply a lubricant to an image bearing member, an image forming apparatus including the process cartridge, and a method of applying a lubricant used in the process cartridge of the image forming apparatus.

2. Discussion of the Related Art

In a background image forming apparatus including a process cartridge, a lubricant is applied to an image bearing member for reducing or preventing deterioration thereof caused by a charging alternating current, for reducing or preventing filming of toner, external additives and so forth to the image bearing member, and for enhancing transfer ability. It is well known that a brush roller is used to scrape a lubricant in a solid form for applying the lubricant to the image bearing member.

The above-described brush roller for applying a lubricant or a lubricant applying brush roller may be rotated with the image bearing member at substantially the same linear velocity as the image bearing member. When the brush roller is rotated in a direction opposite to the image bearing member, the rotation load of the lubricant applying brush roller may increase so that the load to a driving portion may also increase. With the above-described condition, it is required to reinforce the structure and to select a high power motor. Further, the rotation load may easily increase, and can adversely affect image quality. For example, jitter images may be generated.

The lubricant applying brush roller may be driven and rotated in a direction following the image bearing member. When the linear velocity of the lubricant applying brush roller is sufficiently slower than the linear velocity of the image bearing member, residual toner may easily be left on a surface of the image bearing member and/or a lubricant may be applied in an uneven manner.

On the other hand, when the linear velocity of the lubricant applying brush roller is sufficiently faster than the linear velocity of the image bearing member, the rotation load may increase as the lubricant applying brush roller is rotated in a direction opposite to the rotation direction of the image bearing member. This can cause an increase of the rotation load and a production of jitter images due to burden regulation. For the above-described reasons, the lubricant applying brush roller is rotated at substantially the same speed as the image bearing member.

However, when the lubricant applying brush roller is rotated at substantially the same speed as the image bearing member, the lubricant may also be applied unevenly on the surface of the image bearing member due to pitches of fiber bundles of the lubricant applying brush roller.

For example, FIGS. 1 through 4 show a lubricant applying brush roller 217 that may be disposed in contact with an image bearing member 201 so that lubricant can be applied on a surface of the image bearing member 201. As shown in FIG. 1, the lubricant applying brush roller 217 has fiber bundles that are mounted on a surface of the lubricant applying brush roller 217 with a predetermined pitch P.

The lubricant applying brush roller 217 and the image bearing member 201 respectively have a cylindrical shape. However, both the lubricant applying brush roller 217 and the image bearing member 201 in FIGS. 1 through 4 are shown in a flat form as a schematic diagram.

The fiber bundles of the lubricant applying brush roller 217 are mounted such that the respective tips or free ends thereof have an identical height from the surface of the lubricant applying brush roller 217, as shown in FIG. 1. However, when the lubricant applying brush roller 217 contacts the image bearing member 201, the free ends of the fiber bundles of the lubricant applying brush roller 217 can be bent or curved to be unevenly held in contact with the surface of the image bearing member 201, as shown in FIG. 2. Under such condition, the fiber bundles cannot keep the predetermined pitch P.

When the lubricant applying brush roller 217 having such uneven pitches of the free ends of the fiber bundles thereof is used to apply lubricant onto the surface of the image bearing member 201, the amount of applied lubricant may vary on the surface of the image bearing member 201, as shown in FIG. 3. This may generate portions or areas having different amounts of lubricant applied on the surface of the image bearing member 201. When the lubricant applying brush roller 217 carries a small amount of lubricant, the image bearing member 201 may have areas of the surface thereof with little or no lubricant applied thereon.

When the lubricant is unevenly applied on the surface of the image bearing member 201, or when some areas on the surface of the image bearing member 201 have a small amount of lubricant thereon and some have a great amount of lubricant thereon, the applied lubricant cannot effectively and evenly protect the surface of the image bearing member 201.

Under the above-described condition, the surface of the image bearing member 201 may be deteriorated due to application of alternating current by a charging unit. This can easily cause abrasion, poor cleaning ability, and similar problems. Further, quality in image reproduction may adversely be affected due to toner filming, which is adhesion of toner and external additives to the surface of the image bearing member, partially poor transfer ability, and so forth.

Further, the amount of lubricant may be increased so that the areas on the surface having a small amount of lubricant can be reduced or eliminated.

For example, a contact pressure force of the lubricant applying brush roller 217 to a solid lubricant from which the lubricant applying brush roller 217 scrapes lubricant to be applied may be increased to obtain a greater amount of scraped lubricant, as shown in FIG. 4. Thus, the amount of lubricant to be applied to the image bearing member 201 may be increased.

However, when a great amount of lubricant is applied to the surface of the image bearing member 201, an extra amount of lubricant may fall through a cleaning blade (not shown) and adhere to a charging member (not shown). The adhesion of extra lubricant onto the charging member may cause poor chargeability, and can result in reproducing images having background contamination and similar problems adversely affecting to image quality.

Therefore, the lubricant is applied in a limited range. To control the amount of lubricant within the limited range, it is required that the dimensional tolerance of each image forming component and variations of materials of lubricant be strictly reduced. Additionally, an expensive and complicated structure in which a cleaning mechanism for cleaning a charging roller and a cleaning mechanism for cleaning an image bearing member must be added.

Some background image forming apparatuses include different techniques in effectively controlling an amount of lubricant applied to an image forming apparatus.

For example, one technique describes that a lubricant is previously applied to the brush fibers of a rotary brush roller for rubbing and cleaning the surface of an image bearing member disposed in a cleaning unit.

Another technique describes that a cleaning device includes a lubricant applying brush and a cleaning roller for removing residual toner on the surface of an image bearing member before lubricant is applied.

### SUMMARY OF THE INVENTIONS

In one exemplary embodiment, a novel image forming apparatus includes a main body and a process cartridge detachably disposed in the main body of the image forming apparatus. The process cartridge includes an image bearing member configured to bear an image on a surface thereof and rotate at a predetermined linear velocity, and a lubricant applying member disposed in contact with the image bearing member and configured to apply a lubricant on the surface of the image bearing member while rotating with the image bearing member. In the above-described image forming apparatus, the lubricant applying member includes a brush roller and is controlled to rotate at a linear velocity different from the predetermined linear velocity of the image bearing member at a contact portion with the image bearing member so that the lubricant applying member applies an amount of the lubricant smaller than an amount of lubricant used when the image bearing member and the lubricant applying member rotate at an identical linear velocity.

It is to be understood that both the foregoing general description of the inventions and the following detailed description are exemplary, but are not restrictive of the inventions.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings. The accompanying drawings do not wholly represent or in any way limit the scope of the inventions embraced by this specification. The scope of the inventions embraced by this specification and drawings are defined by the words of the properly construed accompanying claims.

FIG. 1 is a diagram of a lubricant applying brush roller;

FIG. 2 is a diagram of the lubricant applying brush roller of FIG. 1 while held in contact with an image bearing member;

FIG. 3 is a diagram of a background condition of application of lubricant by using the lubricant applying brush roller of FIG. 1;

FIG. 4 is a diagram of a different background condition of application of lubricant by using the lubricant applying brush roller of FIG. 1;

FIG. 5 is a schematic structure of a printer according to one exemplary embodiment of the present invention;

FIG. 6 is an example of a process cartridge provided in the printer of FIG. 5, according to an exemplary embodiment of the present invention;

FIG. 7 is a schematic diagram of an example of a condition of application of lubricant performed in the printer of FIG. 5;

FIG. 8A is a drawing of a toner having an “SF-1” shape factor;

FIG. 8B is a drawing of a toner having an “SF-2” shape factor;

FIG. 9A is an outer shape of a toner used in the printer of FIG. 1;

FIG. 9B is a schematic cross sectional view of the toner, showing major and minor axes and a thickness of FIG. 9A; and

FIG. 9C is another schematic cross sectional view of the toner, showing major and minor axes and a thickness of FIG. 9A.

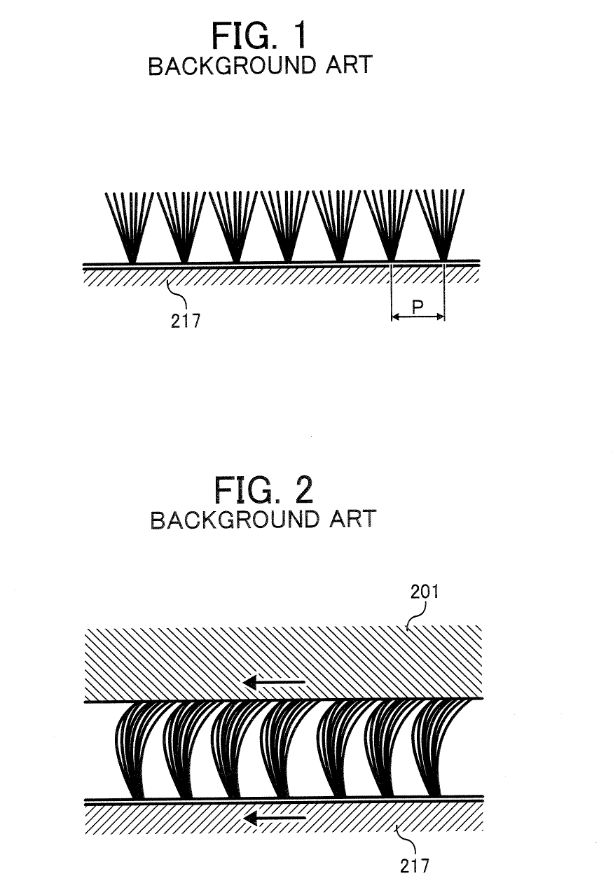

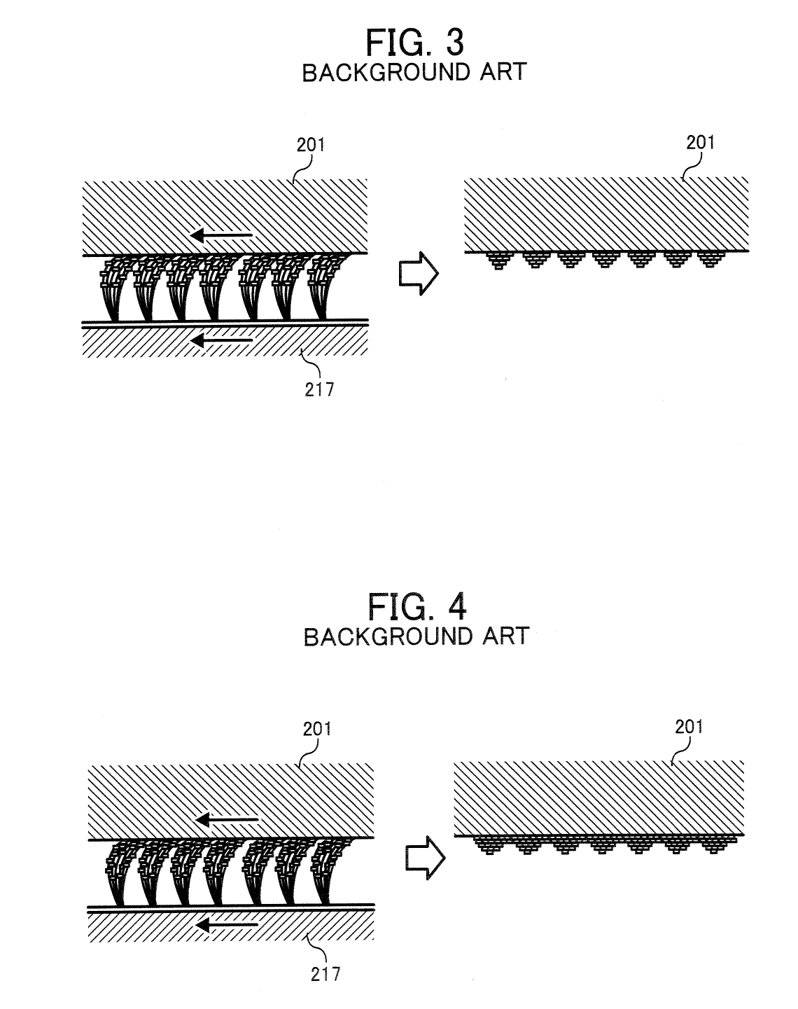

### DETAILED DESCRIPTION OF THE PREFERRED EMBODIMENTS

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, preferred embodiments of the present invention are described.

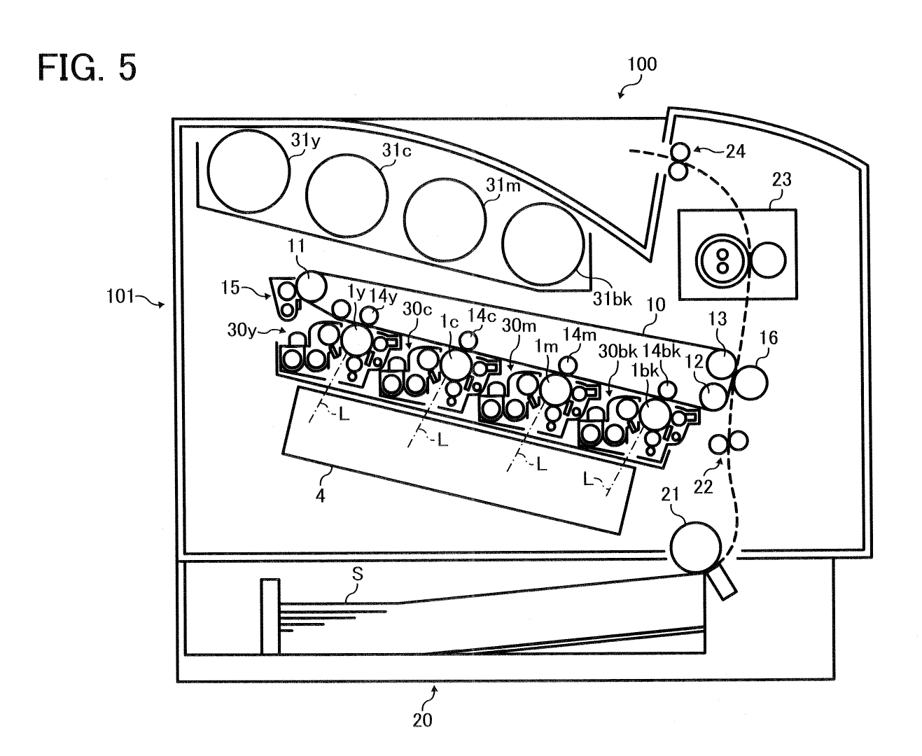

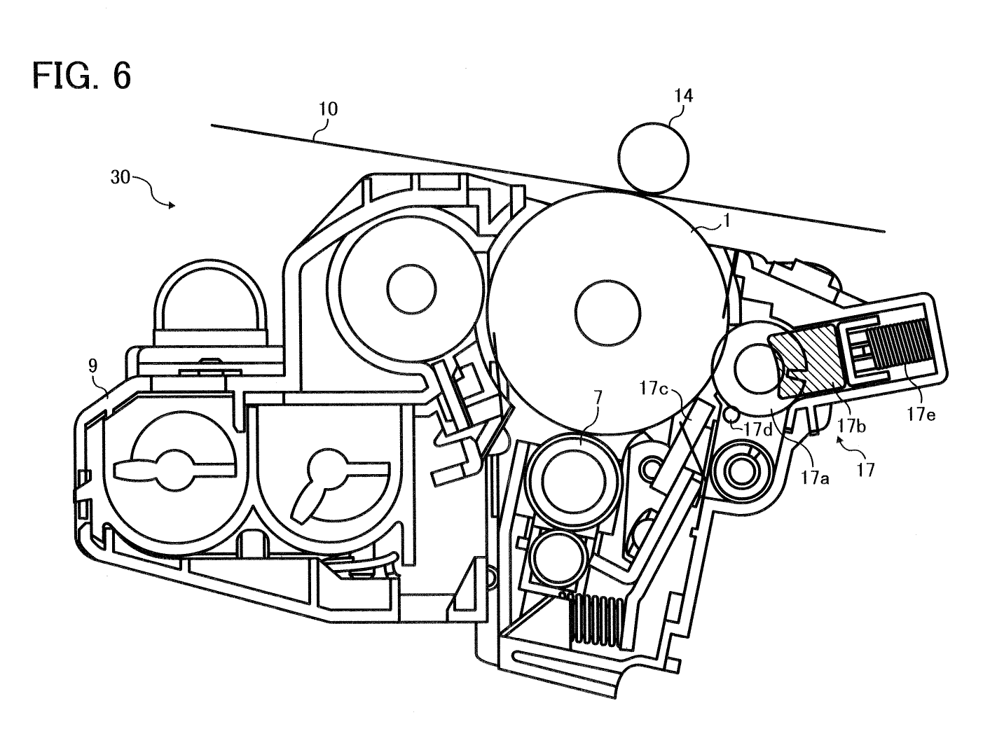

Referring to FIGS. 5 and 6, schematic structures of a printer 100 according to one exemplary embodiment of the present invention are described.

In one exemplary embodiment of the present invention, the printer 100 serves as an image forming apparatus that employs a tandem system for reproducing a full-color image. However, the image forming apparatus enabling the present invention is not limited to the printer 100, but can be applied to a different printer with a different structure, a copier, a facsimile machine, a multi-functional image forming apparatus including at least two functions of a printer, a copier, and a facsimile machine, and other similar image forming apparatus.

FIG. 5 shows an entire structure of the printer 100. The printer 100 includes a sheet feeding mechanism and an image forming mechanism in a main body 101 thereof.

The sheet feeding mechanism includes a sheet feeding cassette 20 disposed at a lower portion of the main body 101. The sheet feeding cassette 20 accommodates recording media including a recording sheet S on top of a sheet stack of recording media. The sheet feeding mechanism further includes a sheet feeding roller 21 and a pair of registration rollers 22.

The sheet feeding roller 21 feeds the transfer sheet S from the top of the sheet stack.

The pair of registration roller 22 stops and feeds the transfer sheet S in synchronization of a movement of the image forming mechanism.

The image forming mechanism includes four image forming units 30y, 30c, 30m, and 30bk, an intermediate transfer belt 10, an optical writing unit 4, and a fixing unit 23.

The image forming units 30y, 30c, 30m, and 30bk include a plurality of photoconductive elements 1y, 1c, 1m, and 1bk, respectively, each of which serving as an image bearing member.

The intermediate transfer belt 10 serves as a flexible intermediate transfer member in a form of an endless belt and is extended by or spanned around a plurality of supporting rollers 11, 12, and 13.

The optical writing unit 4 is disposed at a position below the image forming units 30y, 30m, 30c, and 30bk. The optical writing unit 4 serves as an electrostatic latent image forming unit. Specifically, the optical writing unit 4 emits respective laser light beams L, which are optically modulated, toward the photoconductive elements 1y, 1c, 1m, and 1bk and irradiates the respective surfaces of the photoconductive elements 1y, 1c, 1m, and 1bk to form respective electrostatic latent images.

The fixing unit 23 is disposed at an upper right portion of the main body 101 of the printer 100. The fixing unit 23 fixes an image on a transfer sheet, such as the transfer sheet S, by applying heat and pressure.

The transfer sheet S travels from the sheet feeding cassette 20 to the fixing unit 23 via a sheet conveying path through which the transfer sheet S is conveyed.

The supporting roller 13 of the intermediate transfer belt 10 is disposed opposite to a secondary transfer roller 16 that serves as a secondary transfer unit, sandwiching the intermediate transfer belt 10. A portion between the supporting roller 13 and the secondary transfer roller 16 forms a secondary nip portion along the sheet conveying path.

The supporting roller 11 of the intermediate transfer belt 10 is disposed opposite to a belt cleaning unit 15 that removes residual toner remaining on a surface of the intermediate transfer belt 10.

The image forming units 30y, 30m, 30c, and 30bk are disposed below the intermediate transfer belt 10, facing a lower portion of the intermediate transfer belt 10 formed between the supporting rollers 11 and 12.

As previously described, the image forming units 30y, 30m, 30c, and 30bk include the plurality of photoconductive elements 1y, 1c, 1m, and 1bk, respectively. The photoconductive elements 1y, 1c, 1m, and 1bk are held in contact with an outer surface of the intermediate transfer belt 10 and arranged to face respective primary transfer rollers 14y, 14c, 14m, and 14bk that are held in contact with an inner surface of the intermediate transfer belt 10. The primary transfer rollers 14y, 14c, 14m, and 14bk serve as a primary transfer unit and form respective primary nip portions with respect to the corresponding photoconductive elements 1y, 1c, 1m, and 1bk, respectively.

FIG. 6 shows a schematic structure of one of the image forming units 30y, 30c, 30m, and 30bk.

Since the above-described components indicated by “m”, “c”, “y”, and “bk” used for the image forming operations have similar structures and functions, except that respective toner images formed thereon are of different colors, which are yellow, cyan, magenta, and black toners, the discussion in FIG. 6 uses reference numerals for specifying components of the printer 1 without the suffixes.

In FIG. 6, a plurality of image forming components are disposed around the photoconductive element 1 in the image forming unit 30. The image forming unit 30 of FIG. 6 includes a charging roller 7, a developing unit 9, and a cleaning unit 17.

The charging roller 7 serves as a charging unit and uniformly charges the surface of the photoconductive element 1.

The developing unit 9 develops the electrostatic latent image formed by the optical writing unit 4 on the surface of the photoconductive element 1 into a visible toner image.

The cleaning unit 17 removes residual toner and foreign materials remaining on the surface of the photoconductive element 1.

The image forming unit 30 may also form and be referred to as a “process cartridge 30” in which the photoconductive element 1, the charging roller 7, the developing unit 9, and the cleaning unit 17 are integrally mounted.

As shown in FIG. 5, toner bottles 31y, 31c, 31m, and 31bk are disposed at the upper portion of the main body 101 of the printer 100. The toner bottles 31y, 31c, 31m, and 31bk may also be referred to as a “toner bottle 31” when there is no need to specify color of toner.

The toner bottle 31 is detachable and can separately be replaced when toner in the toner bottle 31 runs out or becomes empty, while the process cartridge 30 may be replaced when the image forming components disposed therein have reached the end of its life.

The toner bottle 31 is separated from the process cartridge 30 and is arranged at the upper portion of the printer 100 to supply toner via a toner conveying member (not shown) to the process cartridge 30. With this structure, when the amount of toner to supply becomes short or runs out, a user can replace the toner bottle 31 but has no need to replace the process cartridge 30 that may still be available to use. Therefore, the user can reduce the cost for the replacement. Further, a user may less often open and close the printer 100 or load and unload the image forming components, the number of maintenance operations can be reduced. The reduction of the number of maintenance operations can reduce or prevent chances of toner scattering and reduce the difficulty of performing maintenance on the printer 100.

Detailed image forming operations performed by the printer 100 are described below, in reference to FIGS. 5 and 6.

When a user starts the image forming operations, a drive unit (not shown) drives and rotates the respective photoconductive elements 1y, 1c, 1m, and 1bk of the image forming units 30y, 30c, 30m, and 30bk in a clockwise direction. The charging roller 7 uniformly charges the respective surfaces of the photoconductive elements 1y, 1c, 1m, and 1bk to a predetermined polarity. The optical writing unit 4 then emits the respective laser light beams L toward the photoconductive elements 1y, 1c, 1m, and 1bk and forms respective electrostatic latent images on the respective surfaces of the photoconductive elements 1y, 1c, 1m, and 1bk. The respective electrostatic latent images are formed according to image data of separated single colors, which are yellow image data, cyan image data, magenta image data, and black image data. The developing unit 9 develops each electrostatic latent image to a visible toner image.

A belt drive unit (not shown) drives and rotates one of the supporting rollers 11, 12, and 13 of the intermediate transfer belt 10 in a clockwise direction to rotate the intermediate transfer belt 10 and cause the other supporting rollers to follow the rotation of the intermediate transfer belt 10.

The respective primary transfer rollers 14y, 14c, 14m, and 14bk cause the corresponding toner images on the photoconductive elements 1y, 1c, 1m, and 1bk, respectively, to be sequentially transferred and overlaid onto the surface of the intermediate transfer belt 10 at the respective primary nip portions. Thus, a full-color toner image may be formed on the surface of the intermediate transfer belt 10.

After the transferring operation of the respective toner images, the photoconductive element 1 may still carry residual toner and have residual electric charge. The cleaning unit 17 removes the residual toner and a discharging unit (not shown) discharges the residual electric charge from the surface of the photoconductive element 1 so that the photoconductive element 1 can be prepared for the next image forming operation.

In synchronization with the image forming operation in the image forming mechanism, the sheet feeding mechanism feeds the transfer sheet S from the sheet feeding cassette 20 via the sheet conveying path toward the pair of registration rollers 22 disposed upstream of the secondary transfer roller 16 in a sheet travel direction. As previously described, the pair of registration rollers 22 stops and feeds the transfer sheet S in synchronization of a movement of the intermediate transfer belt 10 in the image forming mechanism. The transfer sheet S is then conveyed to the secondary nip portion formed between the supporting roller 13 and the secondary transfer roller 16 that is applied with a transfer voltage having a polarity opposite to the toner adhered onto the surface of the intermediate transfer belt 10. At the secondary nip portion, the full-color toner image on the surface of the intermediate transfer belt 10 can be transferred onto a surface of the transfer sheet S. The transfer sheet S having the full-color toner image on the surface thereof is further conveyed to the fixing unit 23. The fixing unit 23 fixes the full-color toner image onto the transfer sheet S by applying heat and pressure. The transfer sheet S having the thus fixed full-color toner image thereon is conveyed to a sheet discharging roller 24 disposed at the upper portion of the main body 101, which is the end of the sheet conveying path, and is discharged to a sheet stacking tray arranged at the top of the main body 101 of the printer 100.

The belt cleaning unit 15 removes residual toner from the surface of the intermediate transfer belt 10 after the full-color toner image is transferred onto the transfer sheet S.

With the above-described structure of the printer 100, the developing unit 9 is provided to each of the photoconductive elements 1y, 1c, 1m, and 1bk disposed opposite to the intermediate transfer belt 10, and the toner images developed by each developing unit 9 are overlaid at one time on the surface of the intermediate transfer belt 10 to form a full-color toner image. Therefore, the printer 100 according to one exemplary embodiment of the present invention can greatly reduce the operating period of time, when compared with an image forming apparatus in which one photoconductive element is provided for four developing units and a full-color toner image is formed on the surface of an intermediate transfer belt in four cycles of rotations of the photoconductive element. Further, since the sheet stacking tray is arranged on top of the main body 101, additional space for the sheet stacking tray can be saved, which can reduce the space and occupancy area for the entire apparatus.

The above-described operations performed by the printer 100 are for producing a full-color image. However, the printer 100 can produce a single, two, or three color image using one, two, or three of the image forming units 30y, 30m, 30c, and 30bk.

For example, when a monochrome image is reproduced, the printer 100 can be controlled to perform the image forming operations for the photoconductive element 1bk.

Referring back to FIG. 6, the process cartridge 30 according to one exemplary embodiment of the present invention further includes a lubricant applying brush roller 17a, a lubricant 17b, a cleaning blade 17c, a flicker 17d, and a biasing member 17e in the cleaning unit 17.

The lubricant applying brush roller 17a of the cleaning unit 17 serves as a lubricant applying member and uses fiber bundles mounted thereon to scrape the lubricant 17b and to apply a scraped portion of the lubricant 17b onto the surface of the photoconductive element 1. The lubricant applying brush roller 17a of the cleaning unit 17 has a linear velocity that is controlled to rotate at a slightly different speed with respect to the linear velocity of the photoconductive element 1. In one exemplary embodiment of the present invention, the linear velocity of the lubricant applying brush roller 17a of the cleaning unit 17 is set to be a slightly or comparatively faster than the linear velocity of the photoconductive element 1.

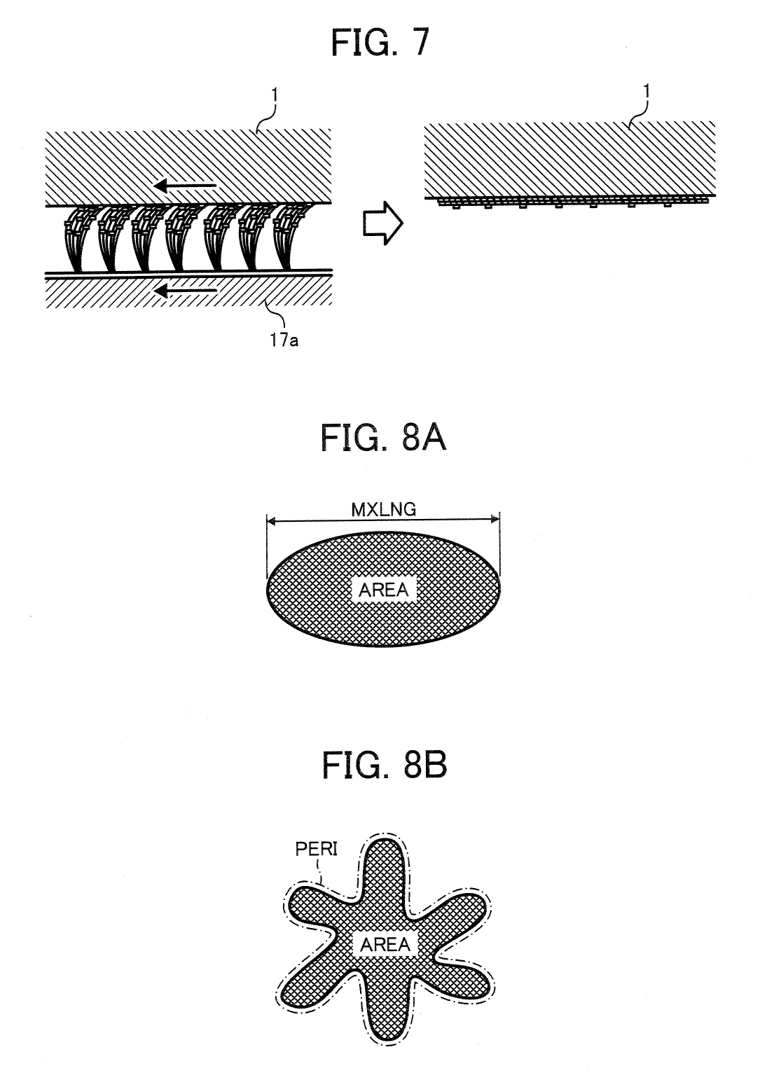

By controlling the linear velocity of the lubricant applying brush roller 17a to be slightly or comparatively faster than that of the photoconductive element 1 as described above, a scraped portion of the lubricant 17b may be applied onto the surface of the photoconductive element 1 while the lubricant applying brush roller 17a rotates in its rotation direction faster than the photoconductive element 1. Even when the lubricant 17b is unevenly applied onto the surface of the photoconductive element 1 due to uneven pitches between the fiber bundles mounted on the lubricant applying brush roller 17a, the fiber bundles of the lubricant applying brush roller 17a can effectively spread or flatten the lubricant 17b over the surface of the photoconductive element 1 to reduce the unevenness of the applied lubricant 17b and to an even a height of a layer of the lubricant 17b on the surface of the photoconductive element 1, as shown in FIG. 7.

Specifically, the lubricant applying brush roller 17a, shown in FIG. 6, may have a diameter of approximately 12 mm, the photoconductive element 1 may have a diameter of approximately 30 mm, and an amount of pressed distance by the lubricant applying brush roller 17a onto the photoconductive element 1 may be approximately 1 mm. Therefore, the actual diameter of the lubricant applying brush roller 17a in the area to which the lubricant applying brush roller 17a is held in contact with the photoconductive element 1 may be approximately 10 mm. Therefore, the linear velocity in the present invention may be calculated based on the condition in which the diameter of the photoconductive element 1 is approximately 30 mm and the actual diameter of the lubricant applying brush roller 17a is approximately 10 mm. The diameter of the lubricant applying brush roller 17a may be identical. However, when the setting of an amount of pressed distance between the lubricant applying brush roller 17a and the photoconductive element 1 is changed, the linear velocity of the lubricant applying brush roller 17a may change. Therefore, the setting may be adjusted to a preferable value, accordingly. The “amount of pressed distance” means a distance of which the lubricant applying brush roller 17a is pressed onto the photoconductive element 1 at a contact portion of the lubricant applying brush roller 17a and the photoconductive element 1.

The lubricant applying brush roller 17a may be formed by or may include one of acrylic fiber, nylon fiber, and PET fiber. The lubricant 17b may include a solid zinc stearate. The lubricant applying brush roller 17a may be pressed into contact with the lubricant 17b at an appropriate value. When the lubricant applying brush roller 17a is held in contact with the photoconductive element 1 under the above-described conditions, the linear velocity of the lubricant applying brush roller 17a with respect to the linear velocity of the photoconductive element 1 is preferably set within a range satisfying a relationship of 0.8≦X<1 or 1≦X<1.3, where “X” represents the linear velocity of the lubricant applying brush roller 17a with respect to the linear velocity of the photoconductive element 1. Specifically, the linear velocity “X” is more preferably set within a range satisfying a relationship of 1<X≦1.3. That is, it is more preferable that the linear velocity of the lubricant applying brush roller 17a is slightly or comparatively faster than the linear velocity of the photoconductive element 1 at a contact portion of the lubricant applying brush roller 17a and the photoconductive element 1.

When the linear velocity of the lubricant applying brush roller 17a is slower than the linear velocity of the photoconductive element 1 at the contact portion, a contact pressure of the lubricant 17b with respect to the lubricant applying brush roller 17a may increase. This may require higher pressure tightness of the lubricant 17b, and cause an increase of costs and a stable sustainment of high contact pressure. Therefore, it is better to rotate the lubricant applying brush roller 17a faster than the photoconductive element 1 so that the contact pressure of the lubricant 17b can be small.

Further, as shown in FIG. 6, the lubricant applying brush roller 17a is disposed upstream of the cleaning blade 17c in a rotation direction of the photoconductive drum 1 to perform as an auxiliary member that can remove the residual toner on the photoconductive element 1. Therefore, the process cartridge 30 including the lubricant applying brush roller 17a can have good cleaning ability in a compact shape.

Also as shown in FIG. 6, the flicker 17d is disposed upstream of the lubricant 17b in the rotation direction of the photoconductive drum 1. After the lubricant applying brush roller 17a has collected residual toner from the surface of the photoconductive element 1, the flicker 17d flicks the residual toner from the lubricant applying brush roller 17a so that the lubricant applying brush roller 17a may not keep the residual toner thereon. Thereby, the lubricant applying brush roller 17a can effectively apply the lubricant 17b with a small amount of toner adhesion on the surface of the photoconductive element 1.

The biasing member 17e shown in FIG. 6 presses the lubricant 17b against the surface of the lubricant applying brush roller 17a.

In one exemplary embodiment of the present invention, the biasing member 17e such as a coil spring is used to determine an amount of consumption of the lubricant 17b. However, the biasing member 17e is not limited to the coil spring. A spindle utilizing gravity can be applied to the biasing member 17e of the present invention.

In one exemplary embodiment of the present invention, the printer 100 can provide the lubricant applying brush roller 17a that can stably apply a small amount of the lubricant 17b to the photoconductive element 1 without causing nonuniformity of the lubricant 17b on the surface of the photoconductive element 1. Actually, it is not impossible to measure the state of the lubricant 17b applying on the surface of the photoconductive element 1. The measurement, however, requires a wide measuring instrument or unit. At the same time, a test material (an image bearing member in this case) may be destroyed or become nonreusable. It is difficult to specify a characteristic value. Therefore, the determination of advantages of the present invention may depend on the confirmation of the following alternative characteristic value.

(1) Measuring the amount of lubricant 17b consumed;

(2) Checking the condition of adhesion of the lubricant 17b to the charging roller 7, measuring the surface potential of the photoconductive element 1 after charging, or checking occurrences of defect images;

(3) Checking the filming or the adhesion of foreign materials to the photoconductive element 1 or confirming occurrence of the filming;

(4) Measuring variations of the rotational speed of the photoconductive element 1 or confirming jitter images.

Now, detailed examples according to the present invention are described below.

### EXAMPLE 1

The material of the lubricant applying brush roller 17a was formed by acrylic fiber. The lubricant includes solid zinc stearate. The initial contact pressure force to the lubricant applying brush roller 17a was 500 mN. The diameter of the lubricant applying brush roller 17a was 12 mm, the diameter of the photoconductive element 1 was 30 mm, and the amount of pressed distance by the lubricant applying brush roller 17a onto the photoconductive element 1 was 1 mm. Accordingly, the actual diameter of the lubricant applying brush roller 17a in the area to which the lubricant applying brush roller 17a was held in contact with the photoconductive element 1 was calculated as 10 mm. The linear velocity of the lubricant applying brush roller 17a was 1.1 times the linear velocity of the photoconductive element 1.

### EXAMPLE 2

The material of the lubricant applying brush roller 17a was formed by acrylic fiber. The lubricant includes solid zinc stearate. The initial contact pressure force to the lubricant applying brush roller 17a was 1,000 mN. The diameter of the lubricant applying brush roller 17a was 12 mm, the diameter of the photoconductive element 1 was 30 mm, and the amount of pressed distance by the lubricant applying brush roller 17a onto the photoconductive element 1 was 1 mm. Accordingly, the actual diameter of the lubricant applying brush roller 17a in the area to which the lubricant applying brush roller 17a was held in contact with the photoconductive element 1 was calculated as 10 mm. The linear velocity of the lubricant applying brush roller 17a was 1.1 times the linear velocity of the photoconductive element 1.

### EXAMPLE 3

The material of the lubricant applying brush roller 17a was formed by acrylic fiber. The lubricant includes solid zinc stearate. The initial contact pressure force to the lubricant applying brush roller 17a was 1,000 mN. The diameter of the lubricant applying brush roller 17a was 12 mm, the diameter of the photoconductive element 1 was 30 mm, and the amount of distance pressed by the lubricant applying brush roller 17a onto the photoconductive element 1 was 1 mm. Accordingly, the actual diameter of the lubricant applying brush roller 17a in the area to which the lubricant applying brush roller 17a was held in contact with the photoconductive element 1 was calculated as 10 mm. The linear velocity of the lubricant applying brush roller 17a was 1.3 times the linear velocity of the photoconductive element 1.

### EXAMPLE 4

The material of the lubricant applying brush roller 17a was formed by acrylic fiber. The lubricant includes solid zinc stearate. The initial contact pressure force to the lubricant applying brush roller 17a was 1,000 mN. The diameter of the lubricant applying brush roller 17a was 12 mm, the diameter of the photoconductive element 1 was 30 mm, and the amount of distance pressed by the lubricant applying brush roller 17a onto the photoconductive element 1 was 1 mm. Accordingly, the actual diameter of the lubricant applying brush roller 17a in the area to which the lubricant applying brush roller 17a was held in contact with the photoconductive element 1 was calculated as 10 mm. The linear velocity of the lubricant applying brush roller 17a was 1.5 times the linear velocity of the photoconductive element 1.

### COMPARATIVE EXAMPLE 1

The material of the lubricant applying brush roller 17a was formed by acrylic fiber. The lubricant includes solid zinc stearate. The initial contact pressure force to the lubricant applying brush roller 17a was 500mN. The diameter of the lubricant applying brush roller 17a was 12 mm, the diameter of the photoconductive element 1 was 30 mm, and the amount of distance pressed by the lubricant applying brush roller 17a onto the photoconductive element 1 was 1 mm. Accordingly, the actual diameter of the lubricant applying brush roller 17a in the area to which the lubricant applying brush roller 17a was held in contact with the photoconductive element 1 was calculated as 10 mm. The linear velocity of the lubricant applying brush roller 17a was 1.0 times the linear velocity of the photoconductive element.

### COMPARATIVE EXAMPLE 2

The material of the lubricant applying brush roller 17a was formed by acrylic fiber. The lubricant includes solid zinc stearate. The initial contact pressure force to the lubricant applying brush roller 17a was 1,000 mN. The diameter of the lubricant applying brush roller 17a was 12 mm, the diameter of the photoconductive element 1 was 30 mm, and the amount of distance pressed by the lubricant applying brush roller 17a onto the photoconductive element 1 was 1 mm. Accordingly, the actual diameter of the lubricant applying brush roller 17a in the area to which the lubricant applying brush roller 17a was held in contact with the photoconductive element 1 was calculated as 10 mm. The linear velocity of the lubricant applying brush roller 17a was 1.0 times the linear velocity of the photoconductive element 1.

### COMPARATIVE EXAMPLE 3

The material of the lubricant applying brush roller 17a was formed by acrylic fiber. The lubricant includes solid zinc stearate. The initial contact pressure force to the lubricant applying brush roller 17a was 1,500 mN. The diameter of the lubricant applying brush roller 17a was 12 mm, the diameter of the photoconductive element 1 was 30 mm, and the amount of distance pressed by the lubricant applying brush roller 17a onto the photoconductive element 1 was 1 mm. Accordingly, the actual diameter of the lubricant applying brush roller 17a in the area to which the lubricant applying brush roller 17a was held in contact with the photoconductive element 1 was calculated as 10 mm. The linear velocity of the lubricant applying brush roller 17a was 1.0 times the linear velocity of the photoconductive element 1.

### COMPARATIVE EXAMPLE 4

The material of the lubricant applying brush roller 17a was formed by acrylic fiber. The lubricant includes solid zinc stearate. The initial contact pressure force to the lubricant applying brush roller 17a was 1,500 mN. The diameter of the lubricant applying brush roller 17a was 12 mm, the diameter of the photoconductive element 1 was 30 mm, and the amount of distance pressed by the lubricant applying brush roller 17a onto the photoconductive element 1 was 1 mm. Accordingly, the actual diameter of the lubricant applying brush roller 17a in the area to which the lubricant applying brush roller 17a was held in contact with the photoconductive element 1 was calculated as 10 mm. The linear velocity of the lubricant applying brush roller 17a was 1.1 times the linear velocity of the photoconductive element 1.

### COMPARATIVE EXAMPLE 5

The material of the lubricant applying brush roller 17a was formed by acrylic fiber. The lubricant includes solid zinc stearate. The initial contact pressure force to the lubricant applying brush roller 17a was 1,500 mN. The diameter of the lubricant applying brush roller 17a was 12 mm, the diameter of the photoconductive element 1 was 30 mm, and the amount of distance pressed by the lubricant applying brush roller 17a onto the photoconductive element 1 was 1 mm. Accordingly, the actual diameter of the lubricant applying brush roller 17a in the area to which the lubricant applying brush roller 17a was held in contact with the photoconductive element 1 was calculated as 10 mm. The linear velocity of the lubricant applying brush roller 17a was 1.5 times the linear velocity of the photoconductive element 1.

<Test>

In the test, an image forming apparatus provided with a process cartridge having the above-described structure was used to perform the image forming operations for a predetermined number of copies under the above-described conditions with the alternative characteristic values. The results are shown in Table 1 below.

In Table 1, “E” represents “Example” and “C” represents “Comparative Example.” That is, Example 1 is described as “E1” and Comparative Example 3 is described as “CE3.” The ranks or levels of each item in the “Result” section were described in initials of “GOOD” for a good condition, and “POOR” for an unacceptable or poor condition. Further, the initial contact pressure force is represented as “Initial Force”, the lubricant applying brush roller is represented as “BR”, the photoconductive element is represented as “PE”, and the charging member is represented

TABLE 1

| | | | Result | | | |
|---|---|---|---|---|---|---|
| | | | Amount of | Foreign | Lubri- | |
| | | | Consumed | Materials | cant | |
| | Condition | | Lubricant | to PE | to CM | |
| | Initial | Linear | after | after | after | |
| | Force of | Velocity | printing | printing | printing | |
| | Lubricant | of BR | 30,000 | 30,000 | 30,000 | Jitter |
| | to BR | to PE | copies | copies | copies | Image |
| E1 | 500 mN | ×1.1 | Small | GOOD | GOOD | GOOD |
| E2 | 1000 mN | ×1.1 | Average | GOOD | GOOD | GOOD |
| E3 | 1000 mN | ×1.3 | Average | GOOD | GOOD | GOOD |
| E4 | 1000 mN | ×1.5 | Average | GOOD | GOOD | POOR |
| CE1 | 500 mN | ×1.0 | Small | POOR | GOOD | GOOD |
| CE2 | 1000 mN | ×1.0 | Average | POOR | GOOD | GOOD |
| CE3 | 1500 mN | ×1.0 | Large | GOOD | GOOD | GOOD |
| CE4 | 1500 mN | ×1.1 | Large | GOOD | POOR | GOOD |
| CE5 | 1500 mN | ×1.5 | Large | GOOD | POOR | POOR |

According to the results shown in Table 1, the examples having the structure according to exemplary embodiments of the present invention could reduce the amount of lubricant consumption and obtain good image quality under the various conditions. On the other hand, when the linear velocity ratio was set to 1.0 times under the comparative examples 1 through 3, that is, when the lubricant applying brush roller 17a rotated with the photoconductive element 1 at the identical speed at the contact portion, the results were not satisfactory. Except, when the initial contact pressure force of the lubricant 17b to the lubricant applying brush roller 17a was set to approximately 1500 mN, the result was satisfactory. Specifically, when the lubricant applying brush roller 17a rotated with the photoconductive element 1 at a different linear velocity from the photoconductive element 1, or at a linear velocity slightly or comparatively faster than the photoconductive element 1 at the contact portion, the lubricant applying brush roller 17a could apply the smaller amount of lubricant when compared with the amount of lubricant used for the lubricant applying brush roller 17a and the photoconductive element 1 rotating at an identical linear velocity.

Further, when the linear velocity of the lubricant applying brush roller 17a with respect to the photoconductive element 1 was set to 1.5 times, the condition of jitter images became worse.

It is noted that the above-described test was also conducted with the materials of a nylon fiber and a PET fiber, and obtained the same results as described above with an acrylic fiber.

It is preferable that an image forming apparatus use toner having high roundness and a shape close to a true sphere. By using such toner, the image forming apparatus may obtain high image quality and high transfer ability, which can provide further effective cleaning ability and application of the lubricant 17b.

Referring to FIGS. 8A and 8B, shapes of a toner particle are described.

It is preferable that high roundness toner having an average roundness equal to or above 0.93 is adopted for use in the developing unit 9 of the printer 100 serving as an image forming apparatus. In related art blade type cleaning, such high roundness toner particles easily enter a space between the photoconductive element 1 and the cleaning blade 17c and cannot be satisfactorily caught. On the other hand, since the lubricant applying brush roller 17a is in contact with the photoconductive element 1 at higher pressure, high transferability can be obtained and less amount of residual toner may remain on the surface of the photoconductive element 1.

A shape factor “SF-1” of the toner used in the image forming apparatus 100 may be in a range from approximately 100 to approximately 180, and the shape factor “SF-2” of the toner is in a range from approximately 100 to approximately 180.

Referring to FIG. 8A, the shape factor “SF-1” is a parameter representing the roundness of a particle. The shape factor “SF-1” of a toner particle is calculated by the following Equation 1:
SF1={(MXLNG)²/AREA}×(100π/4) Equation 1,

where “MXLNG” represents the maximum major axis of an elliptical-shaped figure obtained by projecting a toner particle on a two dimensional plane, and “AREA” represents the projected area of an elliptical-shaped figure.

When the value of the shape factor “SF-1” is 100, the particle has a perfect spherical shape. As the value of the “SF-1” increases, the shape of the particle becomes more elliptical.

Referring to FIG. 8B, the shape factor “SF-2” is a value representing irregularity (i.e., a ratio of convex and concave portions) of the shape of the toner particle. The shape factor “SF-2” of a particle is calculated by the following Equation 2:
SF2={(PERI)²/ AREA}×(100π/4) Equation 2,

where “PERI” represents the perimeter of a figure obtained by projecting a toner particle on a two dimensional plane.

When the value of the shape factor “SF-2” is 100, the surface of the toner is even (i.e., no convex and concave portions). As the value of the “SF-2” increases, the surface of the toner becomes uneven (i.e., the number of convex and concave portions increase).

In this exemplary embodiment of the present invention, toner images are sampled by using a field emission type scanning electron microscope (FE-SEM) S-800 manufactured by HITACHI, LTD. The toner image information is analyzed by using an image analyzer (LUSEX3) manufactured by NIREKO, LTD.

As a toner particle has a higher roundness, the toner particle is more likely to make a point-contact with another toner particle on the image bearing member 100. In this case, the adhesion force between these toner particles is weak, thereby making the toner particles highly flowable. Also, weak adhesion force between the round toner particle and the photoconductive element 1 enhances the transfer rate.

As described above, a higher transfer rate can cause images to be reproduced in higher quality. That is, if a toner image has been developed unevenly, the transferred toner image may also be uneven in development. With the above-described condition, uneven development may become obvious. Therefore, performing the above-described method in combination with an exemplary embodiment of the present invention can provide a developing device that can produce images having high quality and less density nonuniformity. Further, the toner particles having a higher roundness can easily be collected and discharged according to a bias generated by a brush roller.

When SF-1 and SF-2 increase, it may be difficult to collect and discharge the toner particles applied to both positive and negative polarities. The above-described condition may cause ghost images and toner scattering, thereby lower image quality. Therefore, it is preferable that SF-1 and SF-2 do not exceed 180.

Preferably, the toners according to an exemplary embodiment of the present invention have an volume average particle diameter of 3 μm to 8 μm, the ratio of (Dv/Dn) is 1.00 to 1.40, wherein Dv means a volume average particle diameter and Dn means a number average particle diameter. Further, narrower particle diameter distribution may lead to uniform distribution of toner charge and thus high quality images with less fogging of the background, and also a higher transfer rate. This can reduce the amount of toner collection temporarily stored in a collected toner storing unit (not shown) and can enhance the stability of the image forming apparatus, thereby the image forming apparatus can obtain a longer useful life.

However, toner particles having a small diameter tend to have a high content rate of external additives. The high amount of external additives may liberate from the toner particle to induce toner filming on the photoconductive element 1. To prevent the liberation of external additives from a toner particle, the lubricant applying brush roller 17a may apply the lubricant 17b onto the surface of the photoconductive element 1 so as to reduce or prevent the toner filming.

Toner for preferred use in an image forming apparatus according to an exemplary embodiment of the present invention is produced through bridge reaction and/or elongation reaction of a liquid toner material in aqueous solvent. Here, the liquid toner material is generated by dispersing polyester prepolymer including an aromatic group having at least a nitrogen atom, polyester, a coloring agent, and a release agent in organic solvent. In the following, toner constituents and a toner manufacturing method are described in detail.

Toner constituents and a preferable manufacturing method of the toner of an exemplary embodiment of the prevent invention will be described below.

<Modified Polyester>

The toner comprises a modified polyester (i) as a binder resin. A modified polyester indicates a polyester in which a combined group other than ester bond may reside in a polyester resin, and different resin components are combined into a polyester resin through a covalent bond, an ionic bond or the like. Specifically, a modified polyester is one that a functional group such as an isocyanate group or the like, which reacts to a carboxylic acid group and a hydrogen group, is introduced to a polyester end and further reacted to an active hydrogen-containing compound to modify the polyester end.

Examples of the modified polyester (i) include a urea modifed polyester which is obtained by a reaction between a polyester prepolymer (A) having an isocyanate group and amines (B). Examples of the polyester prepolymer (A) having an isocyanate group include a polyester prepolymer which is a polycondensation polyester of a polyvalent alcohol (PO) and a polyvalent carboxylic acid (PC) and having an active hydrogen group is further reacted to a polyvalent isocyanate compound (PIC). Examples of the active hydrogen group included into the above-noted polyester include a hydroxyl group (an alcoholic hydroxyl group and a phenolic hydroxyl group), an amino group, a carboxyl group, and a mercapto group. Among these groups, an alcoholic hydroxyl group is preferable.

A urea-modified polyester is produced as described below.

A polyalcohol (PO) compound may be divalent alcohol (DIO) and tri- or more valent polyalcohol (TO). Only DIO or a mixture of DIO and a small amount of TO may be used. The divalent alcohol (DIO) may be alkylene glycol (ethylene glycol, 1,3-propylene glycol, 1,4-butanediol, 1,6-hexanediol or the like), alkylene ether glycol (diethylene glycol, triethylene glycol, dipropyrene glycol, polyethylene glycol, polypropylene glycol, polytetramethylene ether glycol or the like), alicyclic diol (1,4-cyclohexane dimethanol, hydrogenated bisphenol A or the like), bisphenols (bisphenol A, bisphenol F, bisphenol S or the like), alkylene oxide adducts of above-mentioned alicyclic diols (ethylene oxide, propylene oxide, butylene oxide or the like), and alkylene oxide adducts of the above-mentioned bisphenols (ethylene oxide, propylene oxide, butylene oxide or the like).

Alkylene glycol having 2-12 carbon atoms and alkylene oxide adducts of bisphenols may be used. In particular, the alkylene glycol having 2-12 carbon atoms and the alkylene oxide adducts of bisphenols may be used together. Tri- or more valent polyalcohol (TO) may be tri- to octa or more valent polyaliphatic alcohols (glycerin, trimethylolethane, trimethylol propane, pentaerythritol, sorbitol or the like), tri- or more valent phenols (trisphenol PA, phenol novolac, cresol novolac or the like), and alkylene oxide adducts of tri- or more valent polyphenols.

The polycarboxylic acid (PC) may be divalent carboxylic acid (DIC) and tri- or more valent polycarboxylic acid (TC). Only DIC or a mixture of DIC and a small amount of TC may be used. The divalent carboxylic acid (DIC) may be alkylene dicarboxylic acid (succinic acid, adipic acid, sebacic acid or the like), alkenylene dicarboxylic acid (maleic acid, fumaric acid or the like), and aromatic dicarboxylic acid (phthalic acid, isophthalic acid, terephthalic acid, naphthalene dicarboxylic acid or the like). Alkenylene dicarboxylic acid having 4-20 carbon atoms and aromatic dicarboxylic acid having 8-20 carbon atoms may be used. Tri- or more valent polycarboxylic acid may be aromatic polycarboxylic acid having 9-20 carbon atoms (trimellitic acid, pyromellitic acid or the like). Here, the polycarboxylic acid (PC) may be reacted to the polyalcohol (PO) by using acid anhydrides or lower alkyl ester (methylester, ethylester, isopropylester or the like) of the above-mentioned materials.

A ratio of the polyalcohol (PO) and the polycarboxylic acid (PC) is normally set between 2/1 and 1/1 as an equivalent ratio [OH]/[COOH] of a hydroxyl group [OH] and a carboxyl group [COOH]. The ratio may be in a range from 1.5/1 through 1/1. In particular, the ratio is preferably between 1.3/1 and 1.02/1.

Specific examples of the polyisocyanate (PIC) include aliphatic polyisocyanate such as tetramethylenediisocyanate, hexamethylenediisocyanate and 2,6-diisocyanatemethylcaproate; alicyclic polyisocyanate such as isophoronediisocyanate and cyclohexylmethanediisocyanate; 10 aromatic diisocyanate such as tolylenedisocyanate and diphenylmethanediisocyanate; aroma aliphatic diisocyanate such as αα\acute{α}\acute{α}-te-tramethylxylylenediisocyanate; isocyanurate; the above-mentioned polyisocyanate blocked with phenol derivatives, oxime and caprolactam; and their combinations.

The polyisocyanate (PIC) is mixed with a polyester such that the equivalent ratio ([NCO]/[OH]) between the isocyanate group [NCO] of the polyisocyanate (PIC) and the hydroxyl group [OH] of the polyester may typically be from 5/1 to 1/1, from 4/1 to 1.2/1, and from 2.5/1 to 1.5/1. When [NCO]/[OH] is greater than 5, low temperature fixability of the resultant toner deteriorates. When the molar ratio of [NCO] is less than 1, the urea content in the resultant modified polyester decreases and hot offset resistance of the resultant toner deteriorates.

The content of the constitutional unit obtained from a polyisocyanate (PIC) in the polyester prepolymer (A) may be from 0.5% to 40% by weight, from 1% to 30% by weight, and from 2% to 20% by weight. When the content is less than 0.5% by weight, hot offset resistance of the resultant toner deteriorates and in addition the heat resistance and low temperature fixability of the toner also deteriorate. In contrast, when the content is greater than 40% by weight, low temperature fixability of the resultant toner deteriorates.

The number of the isocyanate groups included in a molecule of the polyester prepolymer (A) may be at least 1, from 1.5 to 3 on average, and from 1.8 to 2.5 on average. When the number of the isocyanate group is less than 1 per 1 molecule, the molecular weight of the urea-modified polyester decreases and hot offset resistance of the resultant toner deteriorates.

Specific examples of the amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diamino cyclohexane and isophoron diamine); aliphatic diamines (e.g., ethylene diamine, tetramethylene diamine and hexamethylene diamine); etc. Specific examples of the polyamines (B2) having three or more amino groups include diethylene triamine, triethylene tetramine. Specific examples of the amino alcohols (B3) include ethanol amine and hydroxyethyl aniline. Specific examples of the amino mercaptan (B4) include aminoethyl mercaptan and aminopropyl mercaptan.

Specific examples of amino acid (B5) are aminopropionic acid and caproic acid. Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc. Among these compounds, diamines (B1) and mixtures in which a diamine is mixed with a small amount of a polyamine (B2) may be used.

The mixing ratio (i.e., a ratio [NCO]/[NHx]) of the content of the prepolymer (A) having an isocyanate group to the amine (B) may be from 1/2 to 2/1, from 1.5/1 to 1/1.5, and from 1.2/1 to 1/1.2. When the mixing ratio is greater than 2 or less than 1/2, molecular weight of the urea-modified polyester decreases, resulting in deterioration of hot offset resistance of the resultant toner.

Suitable polyester resins for use in the toner of an exemplary embodiment of the present invention include a urea-modified polyester (i). The urea-modified polyester (i) may include a urethane bonding as well as a urea bonding. The molar ratio (urea/urethane) of the urea bonding to the urethane bonding may be from 100/0 to 10/90, from 80/20 to 20/80, and from 60/40 to 30/70. When the molar ratio of the urea bonding is less than 10%, hot offset resistance of the resultant toner deteriorates.

The urea-modified polyester (i) for use in an exemplary embodiment of the present invention is prepared by a one-shot process or a prepolymer process. The weight-average molecular weight of the urea-modified polyester (i) may be from 10,000 or more, from 20,000 to 10,000,000, and from 30,000 to 1,000,000. If the weight-average molecular weight is less than 1,000, the hot offset resistance may deteriorate. If the weight-average molecular weight is more than 10,000, the image fixing ability may deteriorate and the manufacturing issues may increase in granulation and pulverization. The number-average molecular weight of the urea-modified polyester (i) is not specifically limited when the unmodified polyester (ii) is used in combination and may be such a number-average molecular weight as to yield the above-specified weight-average molecular weight. If the urea-modified polyester (i) is used alone, the number-average molecular weight thereof is 20,000 or less, may be from 1,000 to 10,000, and from 2,000 to 8,000. If the number-average molecular weight is more than 20,000, the image-fixing properties at low temperatures and glossiness upon use in a full-color apparatus may deteriorate.

If necessary, a reaction terminator may be used for the cross-linking reaction and/or extension reaction of a polyester prepolymer (A) with an amine (B), to control the molecular weight of the resultant urea-modified polyester (i). Specific examples of the reaction terminators include a monoamine such as diethylamine, dibutylamine, butylamine, lauryl amine, and blocked substances thereof such as a ketimine compound.

<Unmodified Polyester>

In an exemplary embodiment of the present invention, not only the modified polyester (i) may be used alone but also an unmodified polyester (ii) may be included together with the modified polyester (i) as binder resin components. Using an unmodified polyester (ii) in combination with a modified polyester (i) is preferable to the use of the modified polyester (i) alone, because low-temperature image fixing properties and gloss properties when used in a full-color device become enhanced. Specific examples of the unmodified polyester (ii) include a polycondensation polyester of a polyvalent alcohol (PO) and a polyvalent carboxylic acid (PC), and the like, same as in the modified polyester (i) components. Preferable compounds thereof are also the same as in the modified polyester (i). As for the unmodified polyester (ii), in addition to an unmodified polyester, it may be a polymer which is modified by a chemical bond other than urea bonds, for example, it may be modified by a urethane bond. It is preferable that at least a part of modified polyester (i) is compatible with part of an unmodified polyester (ii), from the aspect of low-temperature image fixing properties and hot-offset resistivity. Thus, it is preferable that the composition of the modified polyester (i) is similar to that of the unmodified polyester (ii). A weight ratio of a modified polyester (i) to an unmodified polyester (ii) when an unmodified polyester (ii) is being included, is typically 5/95 to 80/20, preferably 5/95 to 30/70, more preferably 5/95 to 25/75, and still more preferably 7/93 to 20/80. When the weight ratio of a modified polyester (i) is less than 5%, it makes hot-offset resistivity degraded and brings about disadvantages in compatibility between heat resistant storage properties and low-temperature image fixing properties.

The molecular weight peak of the unmodified polyester (ii) is typically 1,000 to 10,000, preferably 2,000 to 8,000, and more preferably 2,000 to 5,000. When the molecular weigh peak of the unmodified polyester (ii) is less than 1,000, heat resistant storage properties become degraded, and when more than 10,000, low-temperature image fixing properties become degraded. The hydroxyl value of the unmodified polyester (ii) is preferably 5 or more, more preferably 10 to 120, and still more preferably 20 to 80. When the value is less than 5, it brings about disadvantages in the compatibility between heat resistant storage properties and low-temperature image fixing properties. The acid number of the unmodified polyester (ii) is preferably 1 to 5, and more preferably 2 to 4. Since a wax with a high acid value is used as a binder, a binder with a low acid value is easily matched with a toner used in a two- component developer, because such a binder leads to charging and a high volume resistivity.

The toner binder may have a glass transition temperature (Tg) of from 45° C. to 65° C., and from 45° C. to 60° C. When the glass transition temperature is less than 45° C., the heat conserving resistance of the toner deteriorates. When the glass transition temperature is higher than 65° C., the low temperature fixability deteriorates.

Since the urea-modified polyester can exist on the surfaces of the mother toner particles, the toner of an exemplary embodiment of the present invention has better heat conserving resistance than related art toners including a polyester resin as a binder resin even though the glass transition temperature is low.

<Colorant>

Suitable colorants for use in the toner of an exemplary embodiment of the present invention include any suitable colorant including related art dyes and pigments. Specific examples of the colorants include carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, 25 Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, LitholFast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination.

A content of the colorant in the toner is preferably from 1 to 15% by weight, and more preferably from 3 to 10% by weight, based on total weight of the toner.

The colorants mentioned above for use in an exemplary embodiment of the present invention can be used as master batch pigments by being combined with a resin.

The examples of binder resins to be kneaded with the master batch or used in the preparation of the master batch are styrenes like polystyrene, poly-p- chlorostyrene, polyvinyl toluene and polymers of their substitutes, or copolymers of these with a vinyl compound, polymethyl metacrylate, polybutyl metacrylate, polyvinyl chloride, polyvinyl acetate, polyethylene, polypropylene, polyester, epoxy resins, epoxy polyol resins, polyurethane, polyamides, polyvinyl butyral, polyacrylic resins, rosin, modified rosin, terpene resins, aliphatic and alicyclic hydrocarbon resins, aromatic petroleum resins, chlorinated paraffins, paraffin wax, etc., which can be used alone or in combination.

<Charge Controlling Agent>

Specific examples of the charge controlling agent include known charge controlling agents such as Nigrosine dyes, triphenylmethane dyes, metal complex dyes including chromium, chelate compounds of molybdic acid, Rhodaminedyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, etc. Specific examples of the marketed products of the charge controlling agents include BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative) PR, COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc. Among these materials, materials negatively charging a toner are preferably used.

The content of the charge controlling agent is determined depending on the species of the binder resin used, whether or not an additive is added, the toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large a charge quantity. Consequently, the electrostatic force of a developing roller attracting the toner increases, resulting in deterioration of the fluidity of the toner and decrease of the image density of toner images.

<Releasing Agent>

A wax for use in the toner of an exemplary embodiment of the present invention as a releasing agent has a low melting point of from 50° C. to 120° C. When such a wax is included in the toner, the wax is dispersed in the binder resin and serves as a releasing agent at a location between a fixing roller and the toner particles. Thereby, hot offset resistance can be enhanced without applying an oil to the fixing roller used. Specific examples of the releasing agent include natural waxes such as vegetable waxes, e.g., carnauba wax, cotton wax, Japan wax and rice wax; animal waxes, e.g., bees wax and lanolin; mineral waxes, e.g., ozokelite and ceresine; and petroleum waxes, e.g., paraffin waxes, microcrystalline waxes and petrolatum. In addition, synthesized waxes can also be used. Specific examples of the synthesized waxes include synthesized hydrocarbon waxes such as Fischer-Tropsch waxes and polyethylene waxes; and synthesized waxes such as ester waxes, ketone waxes and ether waxes. In addition, fatty acid amides such as 1,2-hydroxylstearic acid amide, stearic acid amide and phthalic anhydride imide; and low molecular weight crystalline polymers such as acrylic homopolymer and copolymers having a long alkyl group in their side chain, e.g., poly-n-stearyl methacrylate, poly-n- laurylmethacrylate and n-stearyl acrylate-ethyl methacrylate copolymers, can also be used.

These charge controlling agents and releasing agents can be dissolved and dispersed after being kneaded and receiving an application of heat together with a master batch pigment and a binder resin, and can be added when directly dissolved and dispersed in an organic solvent.

<External Additives>

The inorganic particulate material may have a primary particle diameter of from 5×10⁻³ to 2 μm, and from 5×10⁻³ to 0.5 μm. In addition, a specific surface area of the inorganic particulates measured by a BET method may be from 20 to 500 m²/g The content of the external additive may be from 0.01 to 5% by weight, and from 0.01 to 2.0% by weight, based on total weight of the toner.

Specific examples of the inorganic fine grains are silica, alumina, titanium oxide, barium titanate, magnesium titanate, calcium tiatanate, strontium titanate, zinc oxide, tin oxide, quartz sand, clay, mica, wollastonite, diatomaceous earth, chromium oxide, cerium oxide, red oxide, antimony trioxide, magnesium oxide, zirconium oxide, barium sulfate, barium carbonate, calcium carbonate, silicon carbide, and silicon nitride. Among them, as a fluidity imparting agent, hydrophobic silica fine grains and hydrophobic titanium oxide fine grains may be used in combination. Particularly, when such two kinds of fine grains, having a mean grain size of 5×10⁻² μm or below, are mixed together, there can be noticeably enhanced electrostatic and van del Waals forces with the toner. Therefore, despite agitation effected in the developing device for implementing the desired charge level, the fluidity imparting agent does not part from the toner grains and insures desirable image quality free from spots or similar image defects. In addition, the amount of residual toner can be reduced.

Titanium oxide fine grains are desirable for environmental stability and image density stability, but tend to have lower charge start characteristics. Therefore, if the amount of titanium oxide fine particles is larger than the amount of silica fine grains, then the influence of the above side effect increases.

However, so long as the amount of hydrophobic silica fine grains and hydrophobic titanium oxide fine grains is between 0.3 wt. % and 1.5 wt. %, the charge start characteristics are not noticeably impaired, i.e., desired charge start characteristics are achievable. Consequently, stable image quality is achievable despite repeated copying operations.

The toner of an exemplary embodiment of the present invention is produced by the following method, but the manufacturing method is not limited thereto.

<Preparation of Toner>

First, a colorant, unmodified polyester, polyester prepolymer having isocyanate groups and a parting agent are dispersed into an organic solvent to prepare a toner material liquid.

The organic solvent may be volatile and have a boiling point of 100° C. or below because such a solvent is easy to remove after the formation of the toner mother particles. More specific examples of the organic solvent include one or more of toluene, xylene, benzene, carbon tetrachloride, methylene chloride, 1,2-dichloroethane, 1,1,2-trichloroethane, trichloro ethylene, chloroform, monochlorobenzene, dichloroethylidene, methyl acetate, ethyl acetate, methyl ethyl ketone, methyl isobutyl ketone, and so forth. Particularly, the aromatic solvent such as toluene and xylene; and a hydrocarbon halide such as methylene chloride, 1,2-dichloroethane, chloroform or carbon tetrachloride may be used. The amount of the organic solvent to be used may be 0 parts by weight to 300 parts by weight for 100 parts by weight of polyester prepolymer, 0 parts by weight to 100 parts by weight for 100 parts by weight of polyester prepolymer, and 25 parts by weight to 70 parts by weight for 100 parts by weight of polyester prepolymer.

The toner material liquid is emulsified in an aqueous medium in the presence of a surfactant and organic fine particles.

The aqueous medium for use in an exemplary embodiment of the present invention is water alone or a mixture of water with a solvent which can be mixed with water. Specific examples of such a solvent include alcohols (e.g., methanol, isopropyl alcohol and ethylene glycol), dimethylformamide, tetrahydrofuran, cellosolves (e.g., methyl cellosolve), lower ketones (e.g., acetone and methyl ethyl ketone), etc.

The content of the aqueous medium may typically be from 50 to 2,000 parts by weight, and may be from 100 to 1,000 parts by weight, per 100 parts by weight of the toner constituents. When the content is less than 50 parts by weight, the dispersion of the toner constituents in the aqueous medium is not satisfactory, and thereby the resultant mother toner particles do not have a desired particle diameter. In contrast, when the content is greater than 2,000, the manufacturing costs increase.

Various dispersants are used to emulsify and disperse an oil phase in an aqueous liquid including water in which the toner constituents are dispersed. Specific examples of such dispersants include surfactants, resin fine-particle dispersants, etc.

Specific examples of the dispersants include anionic surfactants such as alkylbenzenesulfonic acid salts, a-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethylammonium salts, dialkyldimethylammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycine, di(octylaminoethyle)glycine, and N-alkyl-N,N-dimethylammonium betaine.

A surfactant having a fluoroalkyl group can prepare a dispersion having good dispersibility even when a small amount of the surfactant is used. Specific examples of anionic surfactants having a fluoroalkyl group include fluoroalkyl carboxylic acids having from 2 to 10 carbon atoms and their metal salts, disodium perfluorooctanesulfonylgl-utamate, sodium 3-{omega-fluoroalkyl(C6-C11)oxy}-1-alkyl(C3-C4) sulfonate, sodium, 3-lomega-fluoroalkanoyl(C6-C8)-N-ethylamino}-1-propanesulfonate, fluoroalkyl(C11-C20) carboxylic acids and their metal salts, perfluoroalkylcarboxylic acids (7C-13C) and their metal salts, perfluoroalkyl(C4-C12)sulfonate and their metal salts, perfluorooctanesulfonic acid diethanol amides, N-propyl-N-(2-hydroxyethyl-)perfluorooctanesulfone amide, perfluoroalkyl(C6-C10) sulfoneamidepropyltrimethylammonium salts, salts of perfluoroalkyl(C6-C10)-N-ethylsulfonylglycin, monoperfluoroalkyl(C6-C16)e-thylphosphates, etc.

Specific examples of the marketed products of such surfactants having a fluoroalkyl group include SARFRON® S-111, S-112 and S-113, which are manufactured by ASAHI GLASS CO., LTD.; FLUORAD® FC-93, FC-95, FC-98 and FC-129, which are manufactured by SUMITOMO 3M LTD.; UNIDYNE® DS-101 and DS-102, which are manufactured by DAIKIN INDUSTRIES, LTD.; MEGAFACE® F-110, F-120, F-113, F-191, F-812 and F-833 which are manufactured by DAINIPPON INK AND CHEMICALS, INC.; ECTOP EF-102, 103, 104, 105, 112, 123A, 123B, 306A, 501, 201 and 204, which are manufactured by TOHCHEM PRODUCTS CO., LTD.; FUTARGENT® F-100 and F150 manufactured by NEOS; etc.

Specific examples of the cationic surfactants, which can disperse an oil phase including toner constituents in water, include primary, secondary and tertiary aliphatic amines having a fluoroalkyl group, aliphatic quaternary ammonium salts such as perfluoroalkyl(C6-C10)sulfone-amidepropyltrimethylammonium salts, benzalkonium salts, benzetonium chloride, pyridinium salts, imidazolinium salts, etc. Specific examples of the marketed products thereof include SARFRON S-121 (manufactured by ASAHI GLASS CO., LTD.); FLUORAD® FC-135 (manufactured by SUMITOMO 3M LTD.); UNIDYNE DS-202 (manufactured by DAIKIN INDUSTRIES, LTD.); MEGAFACE® F-150 and F-824 (manufactured by DAINIPPON INK AND CHEMICALS, INC.); ECTOP EF-132 (manufactured by TOHCHEM PRODUCTS CO., LTD.); FUTARGENT® F-300 (manufactured by NEOS); etc.

Resin fine particles are added to stabilize toner source particles formed in the aqueous solvent. The resin fine particles may be added such that the coverage ratio thereof on the surface of a toner source particle can be within 10% through 90%. For example, such resin fine particles may be methyl polymethacrylate particles of 1 μm and 3 μm, polystyrene particles of 0.5 μm and 2 μm, poly(styrene-acrylonitrile)particles of 1 μm, commercially, PB-200 (manufactured by KAO Co.), SGP, SGP-3G (manufactured by SOKEN), technopolymer SB (manufactured by SEKISUI PLASTICS CO., LTD.), micropearl (manufactured by SEKISUI CHEMICAL CO., LTD.) or the like.

Also, an inorganic dispersant such as calcium triphosphate, calcium carbonate, titanium oxide, colloidal silica, and hydroxyapatite may be used.

Further, it is possible to stably disperse toner constituents in water using a polymeric protection colloid in combination with the inorganic dispersants and/or particulate polymers mentioned above. Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., 62 -hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g., acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethyleneimine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethylcellulose and hydroxypropylcellulose, can also be used as the polymeric protective colloid.

The dispersion method is not particularly limited, and related art dispersion facilities, e.g., low speed shearing type, high speed shearing type, friction type, high pressure jet type and ultrasonic type dispersers can be used. Among them, the high speed shearing type dispersion methods may be used for preparing a dispersion including grains with a grain size of 2 μm to 20 μm. The number of rotations of the high speed shearing type dispersers is not particularly limited, but is usually 1,000 rpm (revolutions per minute) to 30,000 rpm, and may be from 5,000 rpm to 20,000 rpm. While the dispersion time is not limited, it is usually 0.1 minute to 5 minutes for the batch system. The dispersion temperature may be from 0° C. to 150° C., and from 40° C. to 98° C. under a pressurized condition.

At the same time as the production of the emulsion, an amine (B) is added to the emulsion to be reacted with the polyester prepolymer (A) having isocyanate groups.

The reaction causes the crosslinking and/or extension of the molecular chains to occur. The elongation and/or crosslinking reaction time is determined depending on the reactivity of the isocyanate structure of the prepolymer (A) and amine (B) used, but may typically be from 10 min to 40 hrs, and preferably from 2 hours to 24 hours. The reaction temperature may typically be from 0° C. to 150° C., and from 40° C. to 98° C. In addition, a known catalyst such as dibutyltinlaurate and dioctyltinlaurate can be used. The amines (B) are used as the elongation agent and/or crosslinker.

After the above reaction, the organic solvent is removed from the emulsion (reaction product), and the resultant particles are washed and then dried. Thus, mother toner particles are prepared.

To remove the organic solvent, the entire system is gradually heated in a laminar-flow agitating state. In this case, when the system is strongly agitated in a preselected temperature range, and then subjected to a solvent removal treatment, fusiform mother toner particles can be produced. Alternatively, when a dispersion stabilizer, e.g., calcium phosphate, which is soluble in acid or alkali, is used, calcium phosphate is preferably removed from the toner mother particles by being dissolved by hydrochloric acid or similar acid, followed by washing with water. Further, such a dispersion stabilizer can be removed by a decomposition method using an enzyme.

Then a charge controlling agent is penetrated into the mother toner particles, and inorganic fine particles such as silica, titanium oxide etc. are added externally thereto to obtain the toner of an exemplary embodiment of the present invention.

In accordance with a related art method, for example, a method using a mixer, the charge controlling agent is provided, and the inorganic particles are added.

Thus, a toner having a small particle size and a sharp particle size distribution can be obtained. Moreover, by controlling the stirring conditions when removing the organic solvent, the particle shape of the particles can be controlled so as to be any shape between spherical and rugby ball shape. Furthermore, the conditions of the surface can also be controlled so as to be any condition from a smooth surface to a rough surface such as the surface of pickled plum.

Toner according to an exemplary embodiment of the present invention has a substantially spherical shape as provided by the following shape definition.

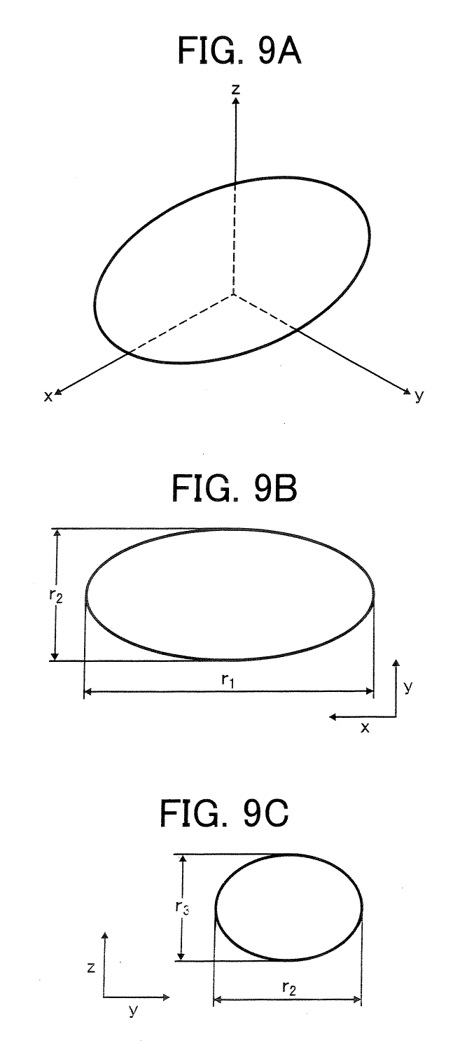

FIGS. 9A through 9C are schematic views showing an exemplary shape of a toner particle according to an exemplary embodiment of the present invention.

An axis x of FIG. 9A represents a major axis r1 of FIG. 9B, which is the longest axis of the toner. An axis y of FIG. 9A represents a minor axis r2 of FIG. 9C, which is the second longest axis of the toner. The axis z of FIG. 9A represents a thickness r3 of FIG. 9B, which is a thickness of the shortest axis of the toner. The toner has a relationship between the major and minor axes r1 and r2 and the thickness r3 as follows:
r1≧r2≧r3.

The toner of FIG. 9A may be in a spindle shape in which the ratio (r2/r1) of the major axis r1 to the minor axis r2 is approximately 0.5 to approximately 1.0, and the ratio (r3/r2) of the thickness r3 to the minor axis is approximately 0.7 to approximately 1.0. Particularly, if the ratio r3/r2 of the thickness and the minor axis is 1.0, the toner particles become rotating objects that rotate around the minor axis as the axis of rotation and the fluidity of the toner can be enhanced, where the lengths r1, r2, and r3 were measured by a scanning electron microscope (SEM) by taking pictures by changing an angle of field of vision and while observing.

The thus prepared toner can be used as a magnetic or non-magnetic one-component developer including no magnetic carrier.

When the toner is used for a two-component developer, the toner is mixed with a magnetic carrier. Suitable magnetic carriers include ferrite and magnetite including a divalent metal atom such as Fe, Mn, Zn, and Cu. The volume average particle diameter of the carrier is preferably from approximately 20 μm to approximately 100 μm. When the particle diameter is less than 20 μm, the problem that the carrier tends to adhere to the photoconductive element 1 during the developing process occurs. In contrast, when the particle diameter is more than 100 μm, the carrier is not mixed well with the toner, resulting in a toner that is insufficiently charged, consequently resulting in poor charging ability during a continuous operation. Among the carrier materials described above, Cu— ferrite including Zn is preferable because it has a high saturation magnetization. However, the carrier is not limited to this example, and a proper carrier may be selected depending on the developing device of the image forming apparatus 100 of an exemplary embodiment of the present invention.

The surface of the carrier may also be coated with a resin such as silicone resins, styrene-acrylic resins, fluorine- containing resins and olefin resins. Such a resin is typically coated on a carrier by the following method:

(1) dissolving a coating resin in a solvent to prepare a coating liquid; and

(2) coating the coating liquid on carrier particles, for example, by a spraying method using a fluidized bed.

Alternatively, the resin can also be coated by the following method:

(1) electrostatically adhering a resin to the surface of carrier particles; and

(2) heating the resin and fixing it to the surface of the carrier particles.

The thickness of the thus formed resin layer on the carrier particles is from approximately 0.05 μm to approximately 10 μm, and preferably from approximately 0.3 μm to approximately 4 μm.

By providing the above-described process cartridge having the structure according to an exemplary embodiment of the present invention, the image forming apparatus can obtain images having high image quality and stability for a long period of time.

Further, the image forming apparatus having the above-described process cartridge may include the least number of replaceable parts, which can contribute to a lesser amount of load to the user and to the environment.

The above-described example embodiments are illustrative, and numerous additional modifications and variations are possible in light of the above teachings. For example, elements and/or features of different illustrative and exemplary embodiments herein may be combined with each other and/or substituted for each other within the scope of this disclosure. It is therefore to be understood that, the disclosure of this patent specification may be practiced otherwise than as specifically described herein.

Obviously, numerous modifications and variations of the present invention are possible in light of the above teachings. It is therefore to be understood that, the invention may be practiced otherwise than as specifically described herein.

### CROSS REFERENCE TO RELATED APPLICATIONS

The present application claims priority to Japanese patent applications no. 2005-345026, filed in the Japan Patent Office on Nov. 30, 2005 and no. 2006-050228, filed in the Japan Patent Office on Feb. 27, 2006, the disclosures of each of which are incorporated by reference herein in their entirety.

What is claimed as new and desired to be secured by Letters: Patent of the United States is:

1. An image forming apparatus, comprising:
a main body; and
a process cartridge detachably disposed in the main body of the image forming apparatus, the process cartridge including
an image bearing member configured to bear an image on a surface thereof and rotate at a predetermined linear velocity, and
a lubricant applying member disposed in contact with the image bearing member and configured to apply a lubricant on the surface of the image bearing member while rotating with the image bearing member,
wherein the lubricant applying member includes a brush roller and is controlled to rotate at a linear velocity different from the predetermined linear velocity of the image bearing member at a contact portion with the image bearing member so that the lubricant applying member applies an amount of the lubricant smaller than an amount of the lubricant used when the image bearing member and the lubricant applying member rotate at an identical linear velocity.

2. The image forming apparatus according to claim 1, wherein:
the lubricant applying member is configured to include one of an acrylic fiber, a nylon fiber, and a PET fiber.

3. The image forming apparatus according to claim 1, wherein:
the lubricant applying member rotates with the image bearing member, and the linear velocity of the lubricant applying member is faster than the linear velocity of the image bearing member at the contact portion.

4. The image forming apparatus according to claim 3, wherein:
the linear velocity of the lubricant applying member with respect to the predetermined linear velocity of the image bearing member is preferably set within a range satisfying a relationship of 1<X≦1.3, where “X” represents a ratio of the linear velocity of the lubricant applying member to the predetermined linear velocity of the image bearing member.

5. The image forming apparatus according to claim 1, wherein:
the lubricant applied by the lubricant applying member includes zinc stearate.

6. The image forming apparatus according to claim 1, wherein:
the lubricant applying member is arranged at a position from which toner remaining on the surface of the image bearing member is removed.

7. The image forming apparatus according to claim 1, further comprising:
a flicker configured to flick residual toner from the lubricant applying member before the lubricant applying member scrapes the lubricant.

8. The image forming apparatus according to claim 1, wherein:
the image forming apparatus is configured to use toner having a volume-based average particle diameter from approximately 3 μm to approximately 8 μm and a distribution from approximately 1.00 to approximately 1.40, wherein the distribution is defined by a ratio of the volume-based average particle diameter to a number-based average diameter.

9. The image forming apparatus according to claim 1, wherein:
the image forming apparatus is configured to use toner having a first shape factor in a range from approximately 100 to approximately 180, and a second shape factor in a range from approximately 100 to approximately 180.

10. The image forming apparatus according to claim 1, wherein:
the image forming apparatus is configured to use toner having a spindle outer shape, and a ratio of a major axis r1 to a minor axis r2 from approximately 0.5 to approximately 1.0 and a ratio of a thickness r3 to the minor axis r2 from approximately 0.7 to approximately 1.0, where r1≧r2≧r3.

11. The image forming apparatus according to claim 1, further comprising:
a toner bottle detachably disposed in the main body of the image forming apparatus and separately arranged from the process cartridge, the toner bottle containing toner to be supplied via a toner conveying member to the process cartridge.

12. A method of applying a lubricant, comprising:
rotating an image bearing member at a predetermined linear velocity; and
rotating a lubricant applying member with the image bearing member at a linear velocity different from the predetermined linear velocity of the image bearing member at a contact portion with the image bearing member so that the lubricant applying member applies an amount of the lubricant smaller than an amount of the lubricant used when the image bearing member and the lubricant applying member rotate at an identical linear velocity.

13. The method according to claim 12, wherein:
the rotating the lubricant applying member includes
controlling the linear velocity of the lubricant applying member to become faster than the predetermined linear velocity of the image bearing member at the contact portion; and
setting the linear velocity of the lubricant applying member with respect to the predetermined linear velocity of the image bearing member within a range satisfying a relationship of 1<X≦1.3, where “X” represents a ratio of the linear velocity of the lubricant applying member with respect to the predetermined linear velocity of the image bearing member.

14. A process cartridge, comprising:
an image bearing member configured to bear an image on a surface thereof and rotate at a predetermined linear velocity; and
a lubricant applying member disposed in contact with the image bearing member and configured to apply a lubricant on the surface of the image bearing member while rotating with the image bearing member,
wherein the lubricant applying member includes a brush roller and is controlled to rotate at a linear velocity different from the predetermined linear velocity of the image bearing member at a contact portion of the image bearing member and the lubricant applying member so that the lubricant applying member applies an amount of the lubricant smaller than an amount of the lubricant used when the image bearing member and the lubricant applying member rotate at an identical linear velocity.

15. The process cartridge according to claim 14, wherein:
the lubricant applying member is configured to include one of an acrylic fiber, a nylon fiber, and a PET fiber.

16. The process cartridge according to claim 15, wherein:
the lubricant applying member rotates with the image bearing member, and the linear velocity of the lubricant applying member is faster than the linear velocity of the image bearing member at the contact portion.

17. The process cartridge according to claim 16, wherein:
the linear velocity of the lubricant applying member with respect to the predetermined linear velocity of the image bearing member is preferably set within a range satisfying a relationship of 1<X≦1.3, where “X” represents a ratio of the linear velocity of the lubricant applying member with respect to the predetermined linear velocity of the image bearing member.

18. The process cartridge according to claim 14, wherein:
the lubricant applied by the lubricant applying member includes zinc stearate.

19. The process cartridge according to claim 14, wherein:
the lubricant applying member is arranged at a position from which toner remaining on the surface of the image bearing member is removed.

20. The process cartridge according to claim 14, further comprising:
a flicker configured to flick residual toner from the lubricant applying member before the lubricant applying member scrapes the lubricant.
